(19) United States
(12) Patent Application Publication
(10) Pub. No.: US 2011/0040987 A1
(43) Pub. Date: Feb. 17, 2011

(54) TIME AVERAGED DYNAMIC PHASE SHEDDING

(75) Inventors: John Loffink, Austin, TX (US); George G. Richards, III, Round Rock, TX (US)

Correspondence Address: HAYNES AND BOONE, LLP;IP Section, 2323 Victory Avenue, Suite 700, Dallas, TX, 75219, US

(73) Assignee: DELL PRODUCTS L.P., Round Rock, TX (US)

(21) Appl. No.: 12/540,048

(22) Filed: Aug. 12, 2009

(51) Int. Cl. G06F 1/26; G05F 1/00

(52) U.S. Cl. 713/300; 323/285

(57) ABSTRACT

A time averaged dynamic phase shedding system includes a system to generate a first phase electrical pulse using a phase 1 pulse generator and generate a second phase electrical pulse using a phase 2 pulse generator. The electrical current of the first phase electrical pulse and the electrical current of the second phase electrical pulse are sensed. The electrical pulses are combined into an output signal where a voltage level of the output signal is sensed. The time averaged dynamic phase shedding system turns off the phase 2 pulse generator in response to an average output current being below a current threshold and turns on the phase 2 pulse generator in response to the output signal having a change in output voltage with respect to the change in time (dv/dt) outside of a dv/dt threshold.

### BACKGROUND

The present disclosure relates generally to information handling systems, and more particularly to time averaged dynamic phase shedding for an information handling system.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

A voltage regulator/converter is an electrical device designed to automatically maintain a relatively constant voltage level on an electrical circuit. A technique of phase shedding for electrical power converters has been used as a way to improve power converter efficiency when less power is consumed. A converter/regulator has an increased efficiency with an increased number of phases in operation converting the power for consumption. As the phase count increases, a heavy load efficiency improves, but a light load efficiency degrades. To overcome this problem, the regulator may be designed to shed the extra phases in periods of lower power demand. Phase shedding improves the efficiency of the converter system by operating only the number of phases necessary for a given load demand. Therefore, voltage regulators for IHSs may be designed using multiple electrical phases for more efficient power conversion.

Voltage regulators for an IHS traditionally use a system of logical signals in combination with lookup tables, processor performance state (P State) information or other system configuration information to indicate when that voltage regulator should add or remove phases to perform phase number adjustments. IHS processors include a logical signal indicating that the processor will enter a low power state and that the corresponding voltage regulator supplying power to the processor should operate only one phase. Then, when the processor resumes normal operation, the regulator is commanded to turn all available phases back on in preparation of a full power load. Thus, commands from the processor only allow for two states, one phase on and all phases on. However, some voltage regulators allow use of any number of available phases (e.g., 1, 2, 3, 4, 5, 6) to be controlled independently. Thus, some available phase combinations remain unused. Additionally, there are times when running all phases is not the most efficient operating mode for the regulator. As such, these systems may not optimize efficiency by running only needed phases, according to actual power usage.

Accordingly, it would be desirable to provide for improved time averaged dynamic phase shedding for an IHS.

### SUMMARY

According to one embodiment, a time averaged dynamic phase shedding system includes a system to generate a first phase electrical pulse using a phase 1 pulse generator and generate a second phase electrical pulse using a phase 2 pulse generator. The electrical current of the first phase electrical pulse and the electrical current of the second phase electrical pulse are sensed. The electrical pulses are combined into an output signal where a voltage level of the output signal is sensed. The time averaged dynamic phase shedding system turns off the phase 2 pulse generator in response to an average output current being below a current threshold and turns on the phase 2 pulse generator in response to the output signal having a change in output voltage with respect to the change in time (dv/dt) outside of a dv/dt threshold.

### BRIEF DESCRIPTION OF THE DRAWINGS

FIG. 1 illustrates an embodiment of an IHS.

FIG. 2 is a graph illustrating a phase count transition point using a comparison between a number of voltage regulator phases and efficiency for an embodiment of an IHS.

FIGS. 3A illustrates an embodiment of a time averaged dynamic phase shedding circuit.

FIG. 3B illustrates an embodiment of graphs of Vout (volts) for phase 1 and phase 2.

FIGS. 4 illustrates the embodiment of a time averaged dynamic phase shedding circuit of FIG. 3A in a time-averaged current operation mode.

FIGS. 5 illustrates the embodiment of a time averaged dynamic phase shedding circuit of FIG. 3A in a dv/dt operation mode.

FIG. 6 illustrates a simulated result for a time averaged dynamic phase shedding circuit.

### DETAILED DESCRIPTION

For purposes of this disclosure, an IHS 100 includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS 100 may be a personal computer, a network storage device, or any other suitable device and may vary in size, shape, performance, functionality, and price. The IHS 100 may include random access memory (RAM), one or more processing resources such as a central processing unit (CPU) or hardware or software control logic, read only memory (ROM), and/or other types of nonvolatile memory. Additional components of the IHS 100 may include one or more disk drives, one or more network ports for communicating with external devices as well as various input and output (I/O) devices, such as a keyboard, a mouse, and a video display. The IHS 100 may also include one or more buses operable to transmit communications between the various hardware components.

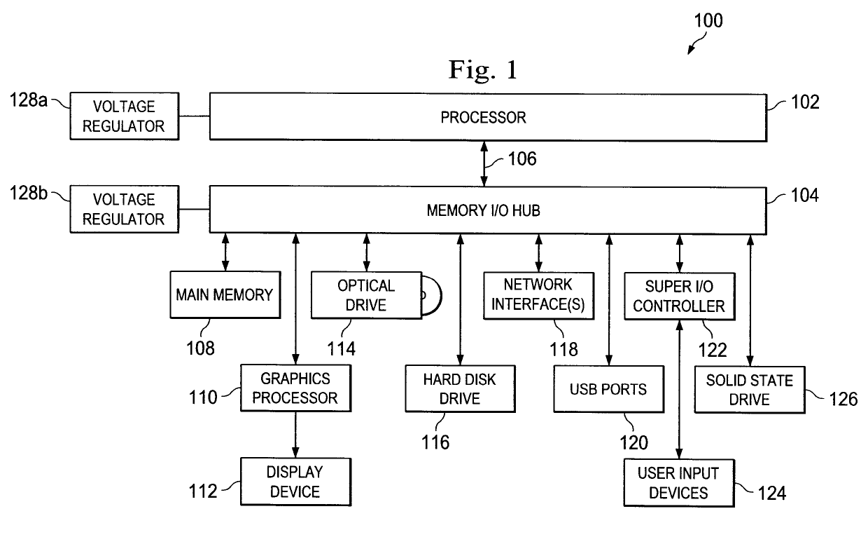

FIG. 1 is a block diagram of one IHS 100. The IHS 100 includes a processor 102 such as an Intel Pentium™ series processor or any other processor available. A memory I/O hub chipset 104 (comprising one or more integrated circuits) connects to processor 102 over a front-side bus 106. Memory I/O hub 104 provides the processor 102 with access to a variety of resources. Main memory 108 connects to memory I/O hub 104 over a memory or data bus. A graphics processor 110 also connects to memory I/O hub 104, allowing the graphics processor to communicate, e.g., with processor 102 and main memory 108. Graphics processor 110, in turn, provides display signals to a display device 112.

Other resources can also be coupled to the system through the memory I/O hub 104 using a data bus, including an optical drive 114 or other removable-media drive, one or more hard disk drives 116, one or more network interfaces 118, one or more Universal Serial Bus (USB) ports 120, and a super I/O controller 122 to provide access to user input devices 124, etc. The IHS 100 may also include a solid state drive (SSDs) 126 in place of, or in addition to main memory 108, the optical drive 114, and/or a hard disk drive 116. It is understood that any or all of the drive devices 114, 116, and 126 may be located locally with the IHS 100, located remotely from the IHS 100, and/or they may be virtual with respect to the IHS 100.

Voltage regulators 128a and 128b may also be coupled to the processor 102 and the memory I/O hub 104, respectively. The voltage regulators 128a and 128b may be combined into one or more voltage regulators and may power other components of the IHS 100. Therefore, the voltage regulators of the present disclosure will be referred to collectively as 128 for the remainder of this disclosure. The voltage regulator 128 provides relatively stable electrical power to the component or components with which it is powering. A voltage regulator 128 may be coupled to a power rail to power many components. Embodiments of the voltage regulator 128 will be discussed in more detail below.

Not all IHSs 100 include each of the components shown in FIG. 1, and other components not shown may exist. Furthermore, some components shown as separate may exist in an integrated package or be integrated in a common integrated circuit with other components, for example, the processor 102 and the memory I/O hub 104 can be combined together. As can be appreciated, many systems are expandable, and include or can include a variety of components, including redundant or parallel resources.

The voltage regulator 128 is an electrical device designed to automatically maintain a relatively constant voltage level on an electrical circuit. The voltage regulator 128 operates by comparing the actual output voltage using a feedback loop to a fixed reference voltage. The voltage difference is amplified and used to control the regulation element in such a way as to reduce the voltage error. The voltage regulator 128 uses multiple electrical phases and phase shedding for a more efficient power conversion.

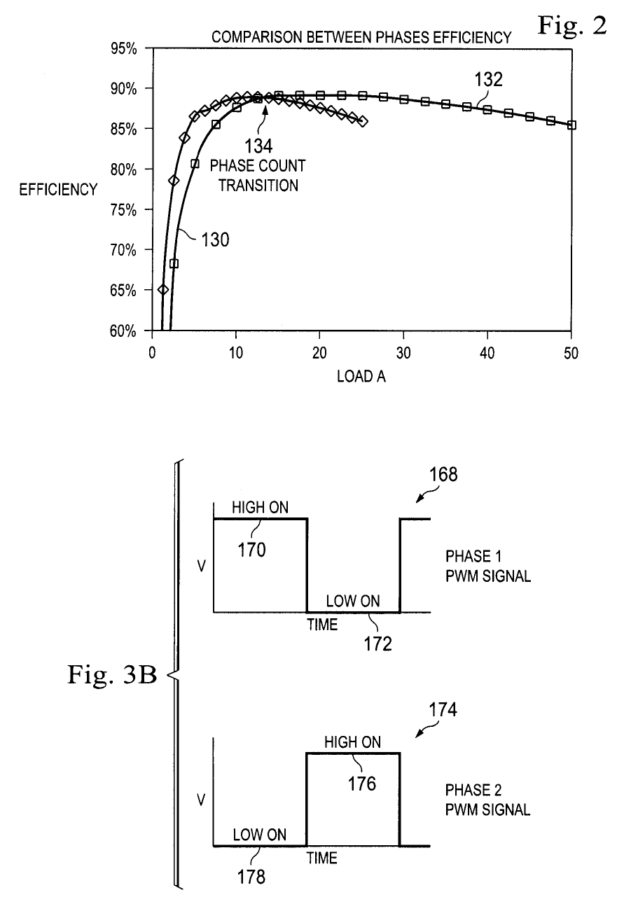

Phase shedding is used to improve voltage regulator/power converter efficiency when different levels of power is consumed. As shown in FIG. 2, the voltage regulator 128 has an increased efficiency with an increased number of phases in operation as the electrical load increases. Specifically, FIG. 2 is a graph illustrating a phase count transition point using a comparison between a number of voltage regulator phases and efficiency for the voltage regulator 128. The voltage regulator 128 load (e.g., amps) is along the “x” axis and the voltage regulator 128 efficiency is along the “y” axis. A first phase efficiency plot 130 is shown on FIG. 2. A second phase efficiency plot 132 is also shown on FIG. 2. In other words, plot 130 shows the efficiency curve for the voltage regulator 128 operating at a given load (e.g., amps). As the load increases, the efficiency using a single phase of the voltage regulator increases to a point and then begins to decrease (130). Similarly, as the load increases, the efficiency using a second phase of the voltage regulator increases to a point and then begins to decrease (132). This trend continues for any number of phases. Thus, as the number of operating phases increases, the higher load efficiency improves, but a light load efficiency degrades.

The voltage regulator 128 sheds or turns off phases that are not needed in periods of lower power demand. The point where the efficiency curves indicate where the voltage regulator 128 should switch from running one phase to running two phases is shown at the phase count transition point 134. As can be seen from this, phase shedding improves the efficiency of the voltage regulator by operating only the number of phases necessary for a given load demand. While FIGS. 2-6 show the voltage regulator 128 having two phases, the present disclosure contemplates a voltage regulator 128 having an optimized phase count having anywhere from one phase turned on to any maximum number of available phases on the voltage regulator 128 that can be turned on. As such, the voltage regulator 128 may have any number of available phases. For example, in an embodiment, the voltage regulator 128 may have 6 phases available. Thus, the present disclosure provides greater control and ability to maximize the voltage regulator 128 conversion efficiency. The present disclosure provides a system of implementing time averaged dynamic phase shedding in DC-DC voltage regulators to optimize the power conversion efficiency based on the dynamic operating conditions of the load.

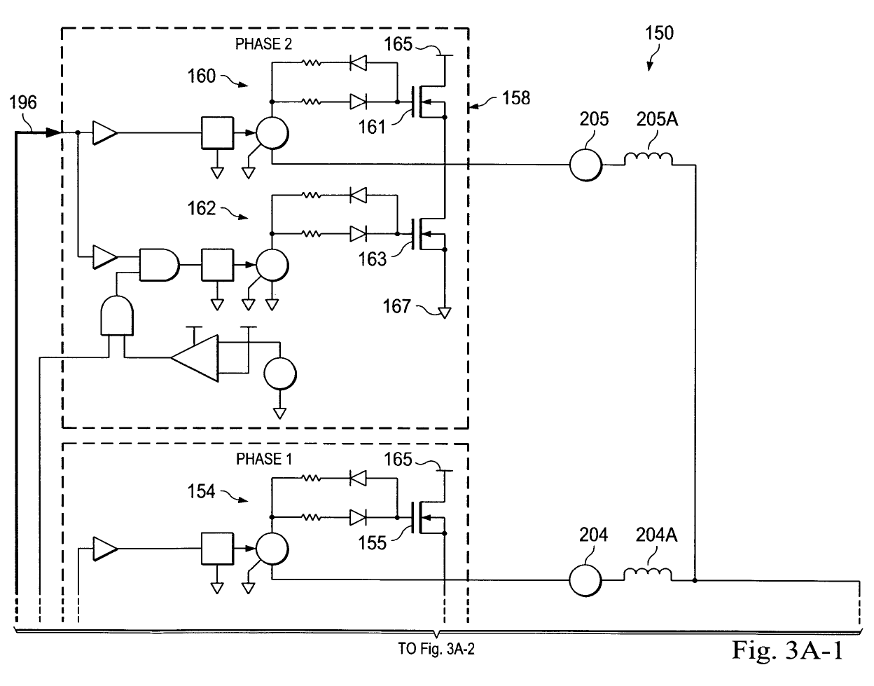

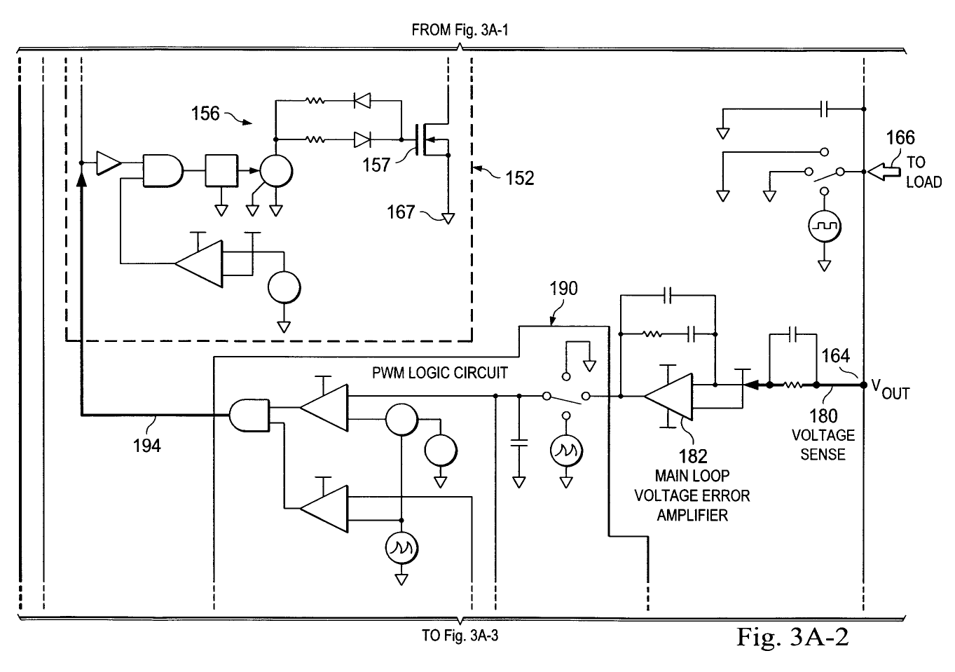

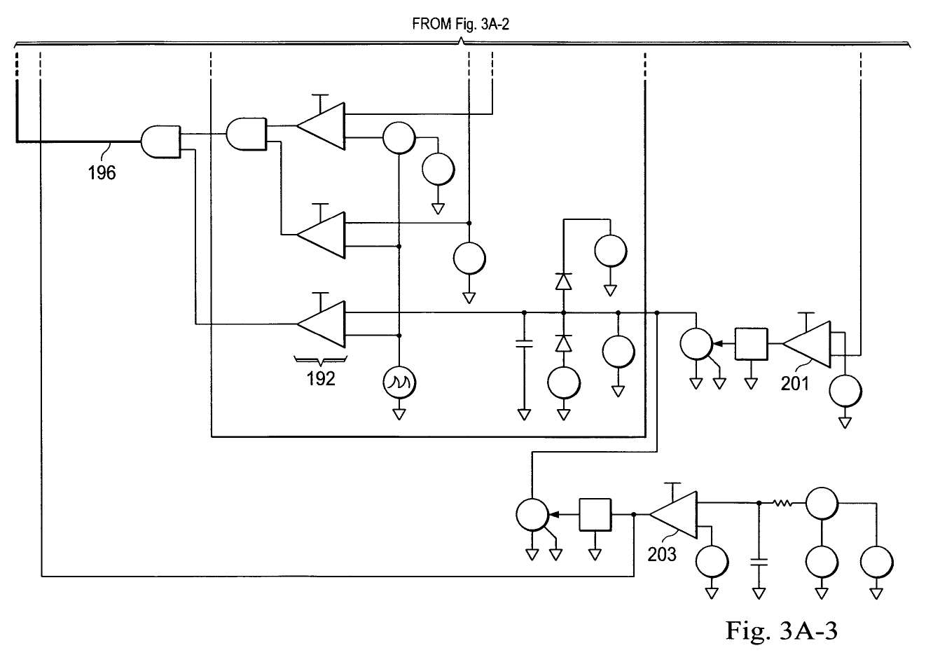

The present disclosure discloses a dynamic phase shedding system that operates by incorporating a slow loop feedback using the average output current and a fast loop feedback that response to the dv/dt or the rate of change of the output voltage present at the output. An embodiment of this is provided in FIGS. 3-5. In the embodiment provided in FIGS. 3-5, the schematic shows the control loop architecture for a two phase, two loop system.

In operation, the voltage regulator 128 uses the present load current value, the time averaged value of the load current and the rate of change value of the output voltage. Using these values, feedback control can be used so that at any given operational condition the optimum number of phases are used and powered to maximize power conversion efficiency. In other words, embodiments of the present disclosure can reduce the number of phases in operation for lower average currents and have the capability to turn on any number of additional phases quickly, as required to meet transient load current increases. As such, the present disclosure takes into account different operating characteristics, load variations, variations in production of silicon devices, such as the processor 102, memory 108, and/or a variety of other components load variations as well as user load variations.

FIGS. 3A, 4 and 5 illustrate an embodiment of a time averaged dynamic phase shedding circuit 150 in different phase modes. In an embodiment, the circuit 150 is substantially similar to the voltage regulators 128a and 128b. The circuit 150 includes a phase 1 generator 152. The phase 1 generator 152 further includes a phase 1 high side 154 and a phase 1 low side 156. The phase 1 high side 154 is driven by a MOSFET 155. The phase 1 low side 156 is driven by a MOSFET 157. The circuit 150 also includes a phase 2 generator 158. The phase 2 generator 158 further includes a phase 2 high side 160 and a phase 2 low side 162. The phase 2 high side 160 is driven by a MOSFET 161. The phase 2 low side 156 is driven by a MOSFET 163. Phase 1 generator 152 and phase 2 generator 158 provide a regulated switched voltage at Vout 164, which provides regulated electrical power to a load, such as at 166. While the phase 1 generator 152 high side 154 and low side 156 and phase 2 generator 158 high side 160 and low side 162 are shown being driven by MOSFETs 155, 157, 161 and 163, it is contemplated that any switching device or transistor may be used to switch electrical power between Vcc 165 and ground (GND) 167. Phase 1 generator 152 and phase 2 generator 158 include other associated devices, such as amplifiers, logical gates, resistors, diodes, power supplies, and other electrical devices to energize gates on each of the MOSFETs 155,157,161 and 163 so that phase 1 generator 152 high side 154 and low side 156 and phase 2 generator 158 high side 160 and low side 162 pass electrical power from VCC 165 and GND 167 to Vout 164 via a source and a drain on each of the MOSFETS 155, 157,161 and 163.

In an embodiment, the phase 1 generator 152 and the phase 2 generator 158 are pulse-width modulation (PWM) generators for the voltage regulator 128. PWM is performed by modulating a duty cycle of the high sides 154 and 160 and the low sides 156 and 162 of each phase 152 and 158 to control the amount of electrical power provided at Vout 164. In an embodiment, the circuit 150 provides an electrical square wave whose pulse width is modulated resulting in the variation of the average value of the waveform. It is contemplated that other waveforms may be used with circuit 150.

As shown on FIG. 3B, graphs of a phase 1 PWM signal 168 and a phase 2 PWM signal 174 are graphed showing voltage versus time to illustrate duty cycle of the PWM signals 168 and 174. As duration of time for high on 170 and 176 and low on time 172 and 178 are modified, the average Vout 164 voltage can be regulated. In an ideal circuit, the voltage value for high on 170 and 176 will be approximately the same value as that of Vcc 165. Similarly, the value for low on 172 and 178 should approximate GND 167. The duty cycles for the PWM signals 168 and 174 may be adjusted to accommodate additional phases.

To modulate the phase 1 generator 152 and phase 2 generator 158, the circuit 150 includes a voltage sense feedback loop 180. The feedback loop 180 provides Vout 164 to a main loop voltage error amplifier 182. The main loop voltage error amplifier 182, in turn, provides an amplified Vout to a series of amplifiers 192 in a PWM logic circuit 190. The PWM logic circuit 190 uses Vout 164 via the voltage sense feedback loop 180 to determine whether high on 170, 176 or low on 172, 178 PWM signals should be provided to Vout 164 and for how long of a duty cycle to reach the desired average voltage value.

To drive the phase 1 generator 152 high side 154 and low side 156, the PWM logic circuit 190 provides a phase 1 PWM trigger signal 194 so that the high side 154 is triggered to increase duty cycle of the phase 1 PWM signal 168 or the low side 156 is triggered to decrease the duty cycle of the phase 1 PWM signal 168. To drive the phase 2 generator 158 high side 160 and low side 162, the PWM logic circuit 190 provides a phase 2 PWM trigger signal 196 so that the high side 160 is triggered to increase duty cycle of the phase 2 PWM signal 174 or the low side 162 is triggered to decrease the duty cycle of the phase 2 PWM signal 174.

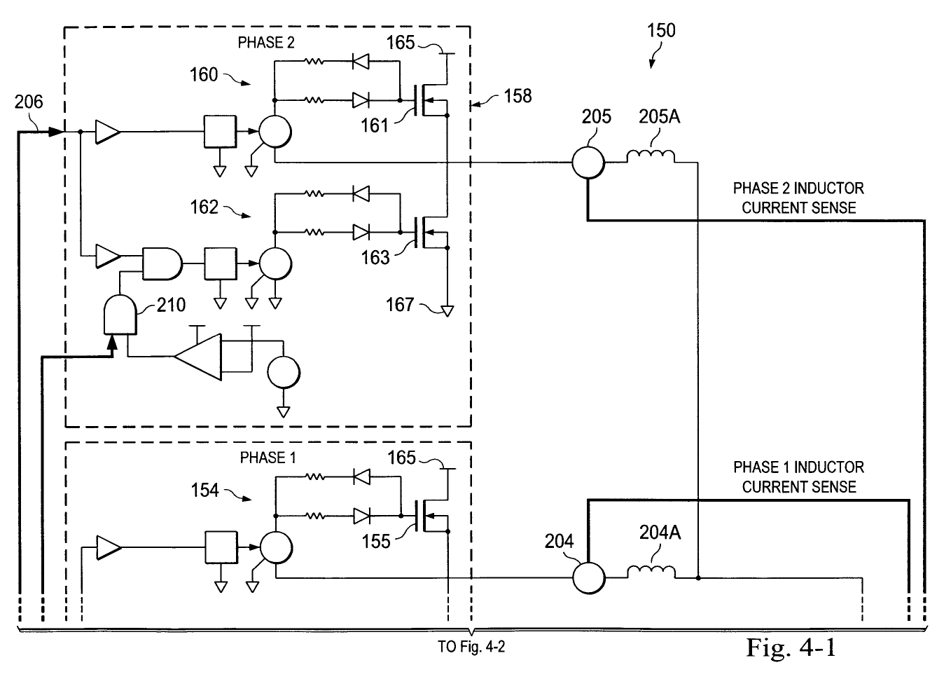

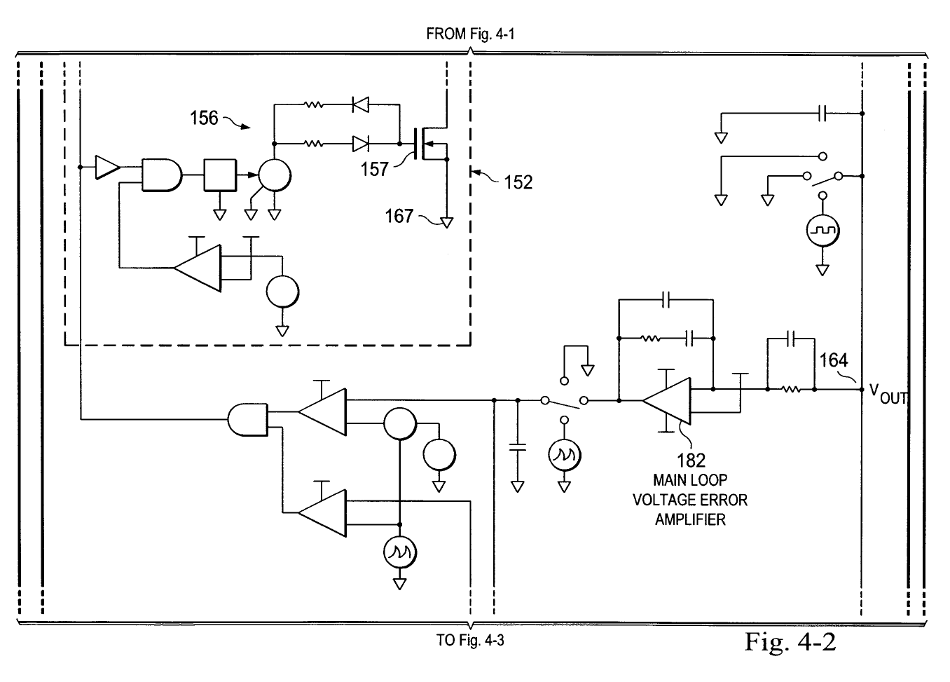

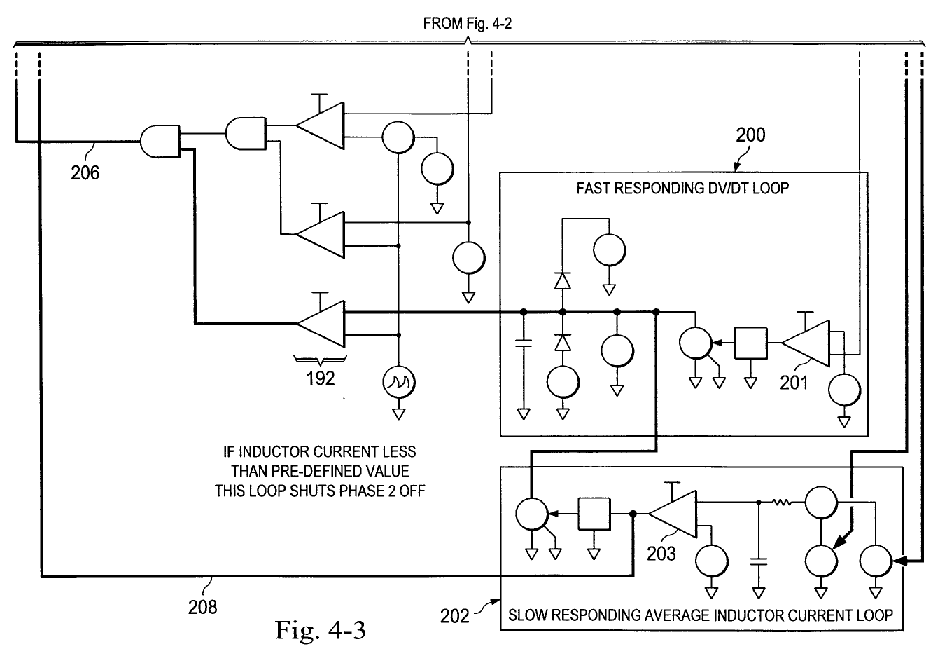

Focusing now on FIG. 4, the time averaged dynamic phase shedding circuit 150 includes a fast responding dv/dt loop circuit 200. The fast responding dv/dt loop circuit 200 includes an amplifier 201. The fast responding dv/dt loop circuit 200 is used to sense a change in Vout 164 relative to time (dv/dt). If Vout 164 falls too much over too short of a time period (e.g., dv/dt is greater than a pre-defined threshold), the amplifier 201, causes the PWM logic circuit 190 to almost instantly turn on the phase 2 high side 160.

The time averaged dynamic phase shedding circuit 150 also includes a slow responding average current loop circuit 202. The slow responding average current loop circuit 202 includes an amplifier 203. The slow responding average current loop circuit 202 is used to sense average current flow from the phase 1 generator 152 using the phase 1 current sensor 204 and the phase 2 generator 158 using the phase 2 current sensor 205. In an embodiment, the current through inductors 204A and 205A is used by current sensors 204 and 205, respectively because current cannot change instantaneously through an inductor. Therefore, average current is sensed and provided to the slow responding average current loop 202. Then, if the average output current falls below a pre-defined value, the slow responding average current loop 202 causes the phase 2 high off signal 206 to turn off the phase 2 high on output 176. Additionally, if the average output current falls below the pre-defined value, the slow responding average current loop 202 uses the phase 2 low side AND gate 210 and causes the phase 2 low on signal 208 to turn on phase 2 low on output 178.

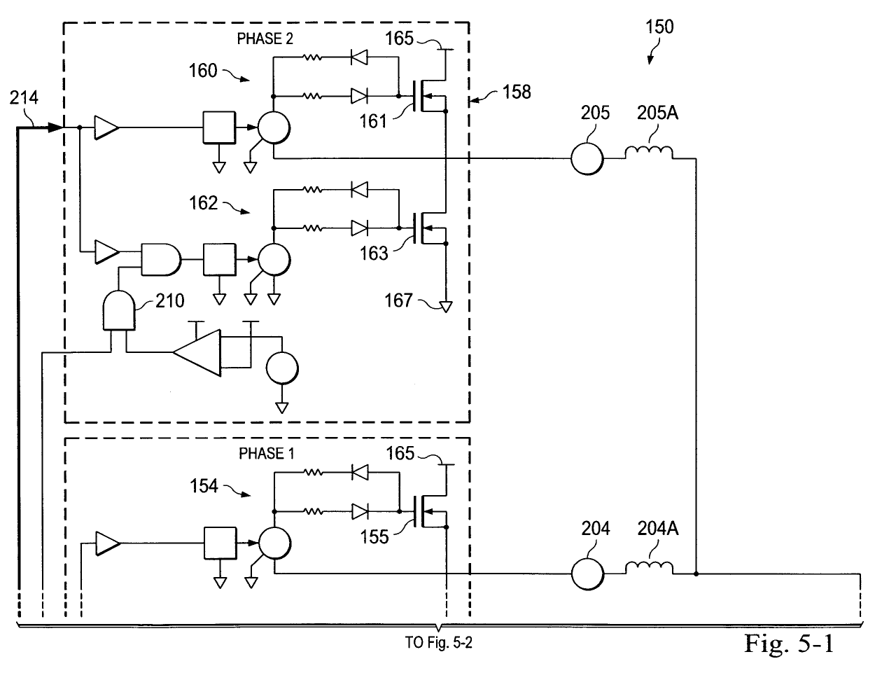

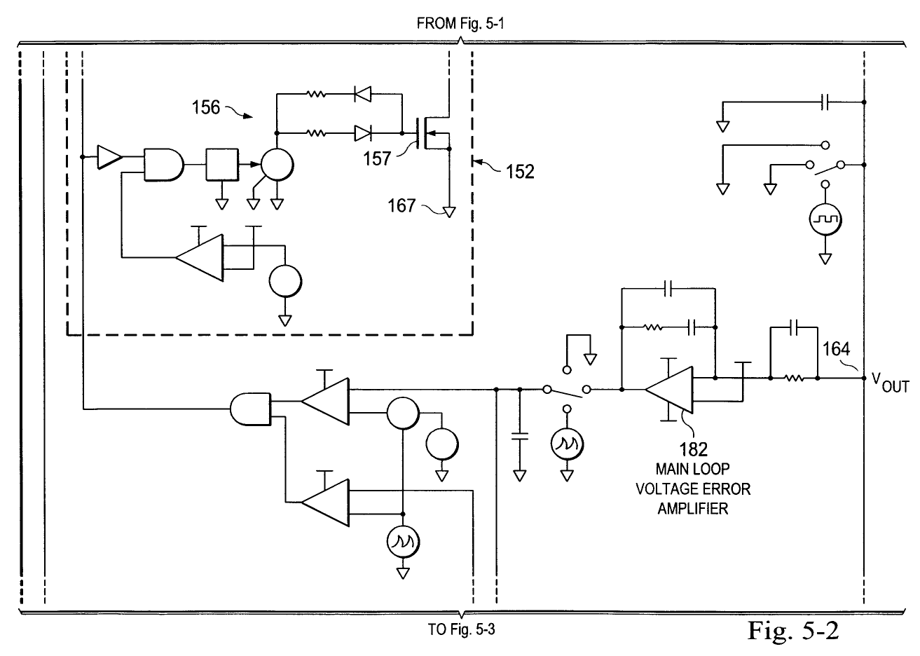

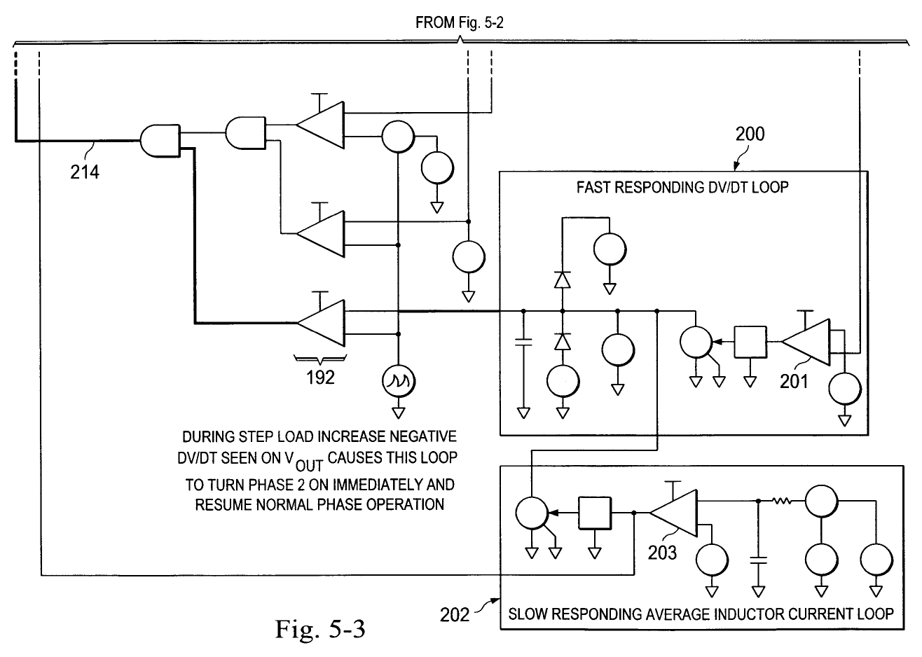

Focusing now on FIG. 5, the fast responding dv/dt loop circuit 200 is used to sense a change in Vout 164 over time (dv/dt) and if the voltage level of Vout 164 falls too much over too short of a time period (e.g., dv/dt is greater than a pre-defined threshold), the amplifier 201, causes the PWM logic circuit 190 to almost instantly turn on the phase 2 high side 160. In other words, during a step load power usage increase for the IHS 100, a negative dv/dt is seen at Vout 164. If this dv/dt exceeds a pre-determined value, this causes the fast responding dv/dt loop 200 to turn the phase 2 generator 158 on substantially instantaneously using the phase 2 resume operational signal 214 and resume normal phase operation.

It should be apparent that some circuit components shown in the figures may be omitted and other circuit components, not shown, may be added, while still embodying the scope of the present disclosure. Additionally, the circuit 150 is shown having two phases for simplicity. However, it should be understood that any number of phases may be used adding corresponding phase generators, PWM logic, dv/dt loops and average current loops to the circuit.

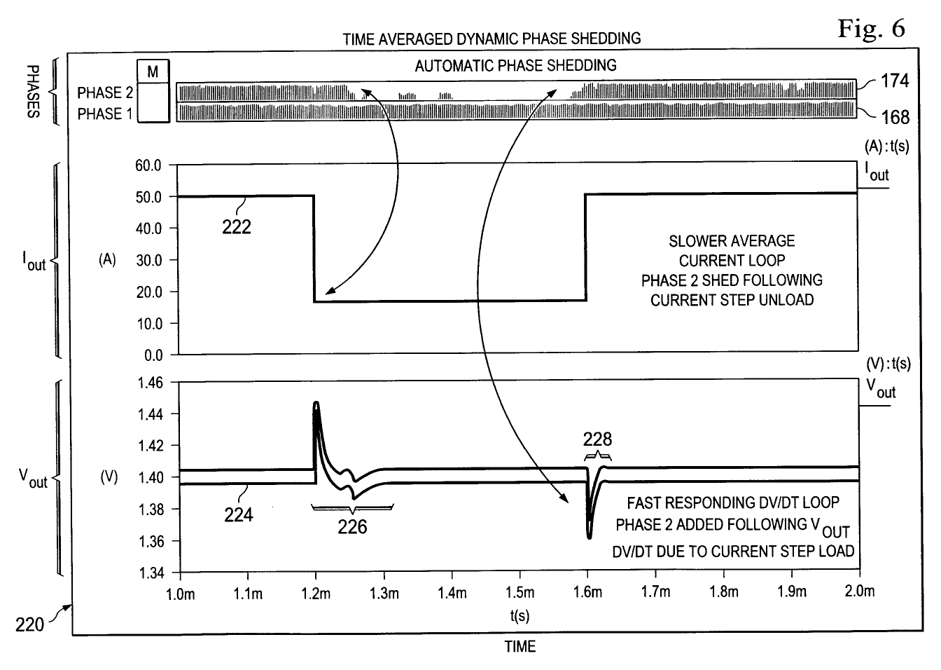

FIG. 6 shows simulation graphical results 220 of phase shedding for the time average dynamic phase shedding system in the embodiment shown in FIGS. 3-5. The graph 220 shows plots of Vout (volts) 224 (e.g., 164), lout (amps) 222 (e.g., at 204 and 204) and phase operation 168 and 174 for phase generators 152, 158, respectively versus time. As can be seen in the graph 220, a positive voltage spike 226 is created when excess phase generators are powering the IHS 100. At the voltage spike 226, the slow responding average current loop 202 causes the phase 2 generator to stop high output generation, thus shedding the phase 2 generator output 174. Conversely, when there is a spike in lout 220, thus creating a negative Vout spike 228, the fast responding dv/dt loop 200 causes the phase 2 generator output 174 to return to operation following Vout 164 and dv/dt due to a current step load power demand.

Embodiments provided herein may be used on any of the IHS 100 subsystem's DC-DC voltage regulators (e.g., processor, memory, etc.) and will perform an optimum phase configuration without additional system information required, other then the load current that the voltage regulator 128 is providing to the load. In an embodiment, this system works where multiple devices are sharing the same power rail and where different power loads have their own dynamic behavior.

In an embodiment, the dynamic time averaged phase shedding control system of the present disclosure may perform dynamic phase shedding based on a particular application's load profile. For example, some applications may be more or less intensive of power utilization on a load like the processor 102 or memory 108. In the case when a particular subsystem is under a heavier or a lighter load, the dynamic time averaged phase shedding of the present disclosure will automatically detect the load condition and re-configure for the optimum phase count.

It is contemplated that in addition to the analog detection methods shown in FIGS. 3-5, high speed digital signal processing systems may be used for both averaged (slow) and dv/dt (fast) response control points. In other words, other embodiments may be implemented using software code to perform phase shedding similar to that provided herein.

The present disclosure reduces system level power consumption by increasing the electrical efficiency of the voltage regulator 128. In an embodiment, the voltage regulator 128 is a DC-DC electrical voltage converter. Embodiments provided herein disclose a voltage regulator 128 that can take into account production variations in electrical loads (e.g., silicon loads, such as processor load, memory load, etc.), variations in environmental conditions (e.g., temperatures), variations in the applications running, and variations in customer usage over time. By taking a filter time average value, embodiments of the present disclosure can determine the proper phase configuration for the voltage regulator 128. Then, in the case of transient load conditions, embodiments of the present disclosure can respond almost immediately by quickly turning on an additional phase or additional phases to meet power delivery requirements.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A system comprising a time averaged dynamic phase shedding circuit to:
generate a first phase electrical pulse using a phase 1 pulse generator;
sense electrical current of the first phase electrical pulse;
generate a second phase electrical pulse using a phase 2 pulse generator;
sense electrical current of the second phase electrical pulse;
combine the electrical pulses into an output signal;
sense a voltage level of the output signal;
turn off the phase 2 pulse generator in response to an average output current being below a current threshold; and
turn on the phase 2 pulse generator in response to the output signal having a dv/dt outside of a dv/dt threshold.

2. The system of claim 1 implemented using an analog electrical circuit.

3. The system of claim 1 implemented using a digital signal processing code.

4. The system of claim 1, wherein the pulse generators are driven using pulse-width modulation.

5. The system of claim 1, wherein the system operates as a DC-DC voltage regulator.

6. The system of claim 5, wherein the voltage regulator provides regulated electrical power to one of a processor and a memory.

7. The system of claim 1 implemented on an information handling system (IHS) server.

8. An information handling system (IHS) comprising:
a processor;
a memory coupled to the processor; and
an electrical circuit coupled to one of the processor and the memory, the circuit including a time averaged dynamic phase shedding system to;
generate a first phase electrical pulse using a phase 1 pulse generator;
sense electrical current of the first phase electrical pulse;
generate a second phase electrical pulse using a phase 2 pulse generator;
sense electrical current of the second phase electrical pulse;
combine the electrical pulses into an output signal;
sense a voltage level of the output signal;
turn off the phase 2 pulse generator in response to an average output current being below a current threshold; and
turn on the phase 2 pulse generator in response to the output signal having a dv/dt outside of a dv/dt threshold.

9. The IHS of claim 8 implemented using an analog electrical circuit.

10. The IHS of claim 8 implemented using a digital signal processing code.

11. The IHS of claim 8, wherein the pulse generators are driven using pulse-width modulation.

12. The IHS of claim 8, wherein the system operates as a DC-DC voltage regulator.

13. The IHS of claim 12, wherein the voltage regulator provides regulated electrical power to one of the processor and the memory.

14. The IHS of claim 8, wherein the IHS is an IHS server.

15. A method performing time averaged dynamic phase shedding, the method comprising:
generating a first phase electrical pulse using a phase 1 pulse generator;
sensing electrical current of the first phase electrical pulse;
generating a second phase electrical pulse using a phase 2 pulse generator;
sensing electrical current of the second phase electrical pulse;
combining the electrical pulses into an output signal;
sensing a voltage level of the output signal;
turning off the phase 2 pulse generator in response to an average output current being below a current threshold; and
turning on the phase 2 pulse generator in response to the output signal having a dv/dt outside of a dv/dt threshold.

16. The method of claim 15 implemented using an analog electrical circuit.

17. The method of claim 15 implemented using a digital signal processing code.

18. The method of claim 15, wherein the pulse generators are driven using pulse-width modulation.

19. The method of claim 15, wherein the system operates as a DC-DC voltage regulator.

20. The method of claim 19, wherein the voltage regulator provides regulated electrical power to one of a processor and a memory.
